(19) United States
(12) Patent Application Publication
(10) Pub. No.: US 2004/0169310 A1
(43) Pub. Date: Sep. 2, 2004

(54) Method for making a longitudinal reinforcing element based on glass fibers, resulting fiber, and article incorporating same

(75) Inventors: Corinne Tonon, Crest (FR); Isabelle Caritey, L'lsle D'Abeau (FR); Pierre-Alain Hutter, Villeurbanne (FR)

Correspondence Address: BURR & BROWN, PO BOX 7068, SYRACUSE, NY, 13261-7068, US

(73) Assignee: Sovoutri Societe Voultaine De Transformes Industriels, Bourgoin Jallieu (FR)

(21) Appl. No.: 10/797,460

(22) Filed: Mar. 10, 2004

Related U.S. Application Data
(63) Continuation of application No. PCT/FR02/02430, filed on Jul. 10, 2002.

(30) Foreign Application Priority Data
Sep. 11, 2001 (FR) 01.11735

(51) Int. Cl. B29C 47/00

(52) U.S. Cl. 264/176.1

(57) ABSTRACT

The invention is aimed at a method for the manufacture of a longitudinal reinforcing element based on glass fibers which is intended to be incorporated in a profiled article based on thermoplastic elastomer.

According to the invention, this method is characterized in that it comprises at least two successive steps, namely:—

a step of preactivation of the glass fibers by immersion in a solution containing a mixture of epoxides and of diisocyanates;

a step of extrusion of the preactivated fibers by means of a thermoplastic material implemented by a reactive group having a chemical reactivity with the epoxides and/or the diisocyanates.

### TECHNICAL FIELD

The invention relates to the field of the textile industry. It is concerned more specifically with the sector of the manufacture of reinforcing elements intended to be incorporated in profiled articles based on thermoplastic elastomer. Some of the these articles are used in the motor vehicle industry, in particular for forming compressible seals, for example in the region of the doors.

The invention is aimed more specifically at a method for the treatment of a glass fiber which makes it possible to use this fiber as reinforcement in the course of extrusion operations during the manufacture of these profiled articles.

### PRIOR ART

Profiled articles produced on an elastomer base are generally extruded in a die from the heated elastomer. Elastomers are generally used for their elasticity qualities which are appreciated when the article thus produced is subjected to frequent compressions. This applies particularly to door seals used in motor vehicles.

A problem arises with regard to profiled elastomeric articles which are extruded. To be precise, when the material cools after extrusion, shrinkage phenomena are seen in the elastomer. This shrinkage may take place over several hours or even over several days. During this period, it is necessary to leave the profiles without any stress, thus preventing them from being used. In other words, production of these profiles by extrusion necessitates a minimum storage period which increases the cost price of such articles.

To solve this problem, it has already been proposed to reinforce the elastomeric profiles by means of longitudinal reinforcing elements. These reinforcements, typically produced from polyester or from glass fibers, have undergone adhesiveness treatment, by virtue of which the elastomeric material adheres firmly to the reinforcements. The shrinkage phenomena are thus blocked by the presence of these reinforcements, on which the elastomeric material is immobilized during cooling. The use of these reinforcements also makes it possible to facilitate the extrusion operations, since the traction is exerted on these reinforcements, not on the actual elastomeric material.

It has also been proposed to produce profiled articles which have greater capacities for the production of complex forms. To be precise, when the articles to be produced have a specific geometry, it may prove expedient to be capable of modeling them accordingly. Consequently, it has been proposed to produce these articles from elastomeric material incorporating thermoplastic compounds. Such compounds have the advantage of being easily fusible, thus facilitating the extrusion and then the shaping operations. They are also more resistant to attacks and to time.

The problem arises when longitudinal reinforcing elements are to be incorporated in these articles based upon thermoplastic elastomers. To be precise, the reinforcements used for profiled articles based solely on elastomers are not compatible with thermoplastic elastomers. In fact, poor adhesion of the thermoplastic elastomer material to the existing reinforcements is observed.

One object of the invention is to make it possible to produce longitudinal reinforcements which have good adhesion characteristics with respect to thermoplastic elastomers.

### PRESENTATION OF THE INVENTION

The invention therefore relates to a method for the manufacture of a longitudinal reinforcing element based on glass fibers, which is to be intended to be incorporated in a profiled article based on thermoplastic elastomer.

According to the invention, this method comprises at least two successive steps, namely:—

a step of preactivation of the glass fibers by immersion in a solution containing a mixture of epoxide and of diisocyanate;

a step of extrusion of a thermoplastic material, implemented by a reactive group having chemical reactivity with the epoxides or the diisocyanates on the preactivated fibers.

In other words, the fibers are first treated by means of a solution of epoxide and of diisocyanate. These molecules have good affinity with glass and cover the fiber with a layer which is subsequently covered with a thermoplastic material by extrusion. This material may be a thermoplastic elastomer or a purely thermoplastic material. When this reinforcement is subsequently placed in the presence of the thermoplastic elastomer of the reinforced article, good adhesion of the fiber thus treated with respect to the mass of the elastomeric thermoplastic material is observed.

In practice, the method may comprise, after the preactivation step, a step of drying of the preactivated fibers. In other words, the first operation of immersing the fiber is carried out in an aqueous solution of epoxide and of diisocyanate or else in a solvent medium. The drying step makes it possible to eliminate the water or the solvent in order to proceed with the subsequent extrusion step.

Should an immersion of the fibers be carried out in an aqueous medium, it will be preferable for the diisocyanates used to be blocked diisocyanates. More specifically, one of the two isocyanate functions of the diisocyanates is unblocked during the preactivation operation, thus enabling it to be grafted onto the glass fibers, in combination with the epoxide groupings. The other isocyanate function located on the opposite side to the glass fiber on the diisocyanate component remains blocked, thus allowing it to be used in an aqueous medium.

Thus, in this case, the method may comprise, before the extrusion step, a step of unblocking the diisocyanates present on the preactivated fibers.

This unblocking may take place either at the end of the drying step or just before the extrusion step. In the second case, this makes it possible to carry out the extrusion operation separately, in time and/or in space, with respect to the preactivation operation.

In practice, it was found that good results are obtained, using, as material for the extrusion step, a thermoplastic material implemented by maleic anhydride groups.

The method described above makes it possible to obtain glass fiber reinforcements which can be incorporated in a large number of profiled articles based on thermoplastic elastomers, in particular seals used in the doors of motor vehicles.

Ways of Putting the Invention into Effect

In order to evaluate the properties of the various reinforcements prepared according to the method, tests were conducted with different pretreatment solutions and with several thermoplastic elastomer materials for the extrusion of the reinforcement. Some reinforcements, using the same preactivation solution and the same extrusion material, were produced under different operating conditions.

The glass fibers used for these tests are fibers sold by the company VETROTEX under the reference EC13 T6. These fibers possess a linear density of 136 tex and a twist in the Z direction of 20 turns. The reinforcement is obtained by the stranding of two ends of such a thread which are treated in parallel.

1/ Preactivation Step

Three preactivation solutions were used, as defined below.

Pretreatment A: The fibers were immersed in a solution with a composition of CILBOND 65W, diluted at 2.85%, sold at 15% of dry extract by the company CIL (Compounding Ingredients Limited). The immersion of the fibers took place in a conventional machine having a die and a doctor blade. The speed of travel of the thread is 17.6 m/min. The tension of the fibers at the entrance of the extruder is 180 grams. After the immersion, the fibers are dried by exposure to a temperature of 160° C. for 30 seconds. A dry reduction of the order of 0.3% was observed.

Pretreatment B: The fibers were immersed in a solution with the composition:

97.10 liters of permuted water;

0.11 kg of sodium carbonate sold by the company Verre Labo Mula;

0.56 liters of surfactant Aerosol OT at 50% sold by the company Cytec;

2.20 liters of glycidyl ether (epoxy), reference GE 100, sold by the company Raschig GmbH;

4 kg of methylenediphenylbishehexahydroazepincarboxamide (blocked diisocyanate), reference Grillbond IL6 at 50%, sold by the company EMS-PRIMID.

The dry extract of this solution is approximately 4.5%.

The immersion of the fibers took place in the same machine as for the pretreatment A with the same speed of travel. After immersion, the fibers are dried by exposure to a temperature of 180° C. for 30 seconds. A dry reduction of the order of 1.5% was observed.

Pretreatment C: The fibers were immersed in a solution of triethoxy-γ-aminosilane, reference AMEO 1100, sold by the company Hüls, at approximately 0.04%. Immersion of the fibers took place in the same machine as for pretreatment A with the same speed of travel. After immersion, the fibers are dried by exposure to a temperature of 160° C. for 30 seconds. A dry reduction of the order of 0.03% was observed.

2/ Extrusion Step

Four different thermoplastic elastomer materials were used in order to carry out the coating step.

Extrusion A: The material used is a polypropylene/ethylene termolymer mixture of propylene and of a diene (EPDM), sold under the reference SANTOPRENE X8291-80TB, by the company Advanced Elastomer Systems (AES). The temperature of the head of the extruder is of the order of 225° C. The temperature of the die through which the thread passes after extrusion is between 225 and 230°. Various tests were carried out, varying the pressure of the extruded thermoplastic elastomer material, the tension applied to the thread and the speed of travel.

Extrusion B: The material used is a polypropylene grafted with a maleic anhydride at a rate greater than 1% and sold under the reference FUSABOND 353 D by the company DUPONT. The temperature of the head of the extruder is of the order of 200° C. The temperature of the die through which the thread passes after extrusion is 205° C. Various tests were carried out, varying the pressure of the extruded thermoplastic elastomer material, the tension applied to the thread and the speed of travel.

Extrusion C: The material used is a polypropylene grafted with a maleic anhydride at a rate of between 0.5 and 1% and sold under the reference EXXELOR PO 1020, by the company EXXON MOBIL CHEMICAL. The temperature of the head of the extruder is of the order of 200° C. The temperature of the die through which the thread passes after coating is 203° C. Various tests were carried out, varying the pressure of the extruded thermoplastic elastomer material, the tension applied to the thread and the speed of travel.

Extrusion D: The material used is a polypropylene grafted with a maleic anhydride at a rate of between 0.25 and 0.5% and sold under the reference EXXELOR PO 1015 by the company EXXON MOBIL CHEMICAL. The temperature of the head of the extruder is of the order of 190° C. The temperature of the die through which the thread passes after extrusion is 191° C. Various tests were carried out, varying the pressure of the extruded thermoplastic elastomer material, the tension applied to the thread and the speed of travel.

For all these tests, the die used for extrusion has a diameter of 0.5 mm.

The following table gives, for various tests carried out:

the type of practivation carried out,

the type of extrusion carried out,

the pressure to which the thermoplastic elastomer material is subjected in the extrusion machine,

the tension measured on the thread, in centinewtons, upstream of the extrusion zone and downstream,

the speed of the thread at the extrusion head in meters per minute,

the reduction, as a percentage, corresponding to the extrusion step,

a qualitative assessment of the stability of the sheath obtained after extrusion,

a qualitative assessment of the appearance of the thread thus obtained.

| | | | | Thread tension | | | | | |
|---|---|---|---|---|---|---|---|---|---|
| | | | Material | (cN) | | | | Stability | |
| | | | pressure | | down | Speed | Reduction | of the | |
| Test No. | Preactivation | Extrusion | (bar) | upstream | stream | (m/min) | (%) | sheath | Appearance |
| 1 | A | A | 40 | 35 | 480 | 15 | 14.5 | satisfactory | flexible |
| | | | | | | | | | thread, |
| | | | | | | | | | round |
| 2 | A | A | 55 | 40 | 420 | 10 | 20.9 | satisfactory | flexible |
| | | | | | | | | | thread, |
| | | | | | | | | | round |
| 3 | A | A | 65 | 40 | 180 | 30 | 21.9 | satisfactory | flexible |
| | | | | | | | | | thread, |
| | | | | | | | | | round |
| 4 | A | A | 65 | 40-50 | 390 | 7 | 28.2 | satisfactory | flexible |
| | | | | | | | | | thread, |
| | | | | | | | | | round |
| 5 | B | A | 65 | 75 | 405 | 7 | 26.7 | high | flexible |
| | | | | | | | | | thread, |
| | | | | | | | | | round |
| 6 | C | A | 65 | 50 | 370 | 7 | 29.5 | high | flexible |
| | | | | | | | | | thread, |
| | | | | | | | | | round |
| 7 | A | B | 6 | 100 | 190 | 7 | 13.4 | satisfactory | round |
| | | | | | | | | | thread, |
| | | | | | | | | | well |
| | | | | | | | | | sheathed |
| 8 | B | B | 6 | | | 7 | 14.9 | high | round |
| | | | | | | | | | thread, |
| | | | | | | | | | well |
| | | | | | | | | | sheathed |
| 9 | B | B | 25 | 110 | 270 | 15 | 19.8 | satisfactory | flat |
| | | | | | | | | | thread, |
| | | | | | | | | | visible |
| | | | | | | | | | filaments |
| 10 | C | B | 6 | 45 | 120 | 7 | 14.2 | high | round |
| | | | | | | | | | thread, |
| | | | | | | | | | well |
| | | | | | | | | | sheathed |
| 11 | C | B | 25 | | 200 | 15 | 21.2 | satisfactory | flat |
| | | | | | | | | | thread, |
| | | | | | | | | | visible |
| | | | | | | | | | filaments |
| 12 | A | C | 10 | 150 | | 7 | 14.5 | satisfactory | round |
| | | | | | | | | | thread, |
| | | | | | | | | | well |
| | | | | | | | | | sheathed |
| 13 | B | C | 10 | | 290 | 7 | 16.4 | high | round |
| | | | | | | | | | thread, |
| | | | | | | | | | well |
| | | | | | | | | | sheathed |
| 14 | C | C | 10 | 117 | 250 | 7 | 15.8 | high | round |
| | | | | | | | | | thread, |
| | | | | | | | | | well |
| | | | | | | | | | sheathed |
| 15 | A | D | 10 | 75 | 300 | 7 | 14.3 | satisfactory | round |
| | | | | | | | | | thread, |
| | | | | | | | | | well |
| | | | | | | | | | sheathed |
| 16 | B | D | 10 | | 300 | 7 | 15.7 | high | round |
| | | | | | | | | | thread, |
| | | | | | | | | | well |
| | | | | | | | | | sheathed |
| 17 | C | D | 10 | | 300 | 7 | 15.6 | high | round |
| | | | | | | | | | thread, |
| | | | | | | | | | well |
| | | | | | | | | | sheathed |
| 18 | C | D | 65 | | 550 | 30 | 24.5 | satisfactory | flat |
| | | | | | | | | | thread, |
| | | | | | | | | | visible |
| | | | | | | | | | filaments |
| 19 | B | B | 10 | 140 | 620 | 30 | 16.9 | satisfactory | round |
| | | | | | | | | | thread, |
| | | | | | | | | | well |
| | | | | | | | | | formed |
| 20 | B | D | 10 | 150 | 600 | 30 | 15.6 | high | round |
| | | | | | | | | | thread, |
| | | | | | | | | | well |
| | | | | | | | | | formed |

Additional measurements were conducted with regard to the two tests bearing numbers 19 and 20.

Thus, the thread obtained in test number 19 has a breaking elongation of 2.48% and an elongation under the load of 30% of 0.75%. Its breaking load is 20.08 kg. Its diameter is 0.4 mm. The dry reduction is 16.9% and its linear density is 221 tex.

Thus, the thread obtained in test number 20 has a breaking elongation of 2.95% and an elongation under the load of 30% of 0.87%. Its breaking load is 23.25 kg. Its diameter is 0.4 mm. Its melting loss is 17% and its linear density is 323 tex.

The adhesion quality of the reinforcing thread obtained according to the invention with respect to the thermoplastic elastomer material of the article to be reinforced can be evaluated by measuring the force necessary for extracting the thread from the thermoplastic elastomer material by traction at 23° C.

The dynamometric measurements obtained for extracting the reinforcing thread from the article of thermoplastic elastomer material give 60 Newton for test No. 19 and 75 Newton for test No. 20. The same test was conducted on a control sample comprising a standard thread of the same length embedded in a rubber casing. The force necessary for extracting the thread is then 45 to 50 Newton.

It may be gathered from the foregoing that the method according to the invention makes it possible to obtain longitudinal reinforcing elements which are compatible with their use in profiled articles based on thermoplastic elastomer. It is thus possible to produce such profiled articles by combining the elasticity qualities imparted by the properties of the elastomer material with resistance to attacks and the durability imparted by the thermoplastic nature of this material. The use of these reinforcements precipitates the extrusion operations and blocks the shrinkage effects during the lowering in temperature of these articles.

1. A method for the manufacture of a longitudinal reinforcing element based on glass fibers, which is intended to be incorporated in a profiled article based on thermoplastic elastomers, characterized in that it comprises at least two successive steps, namely:
a step of preactivation of the glass fibers by immersion in a solution containing a mixture of epoxides and of diisocyanates,
a step of extrusion of the preactivated fibers by means of a thermoplastic material implemented by a reactive group having chemical reactivity with expoxides and/or the diisocyanates.

2. The method as claimed in claim 1, characterized in that the thermoplastic material used for the extrusion step is a thermoplastic elastomer.

3. The method as claimed in claim 1, characterized in that, after the preactivation step, it comprises a step of drying of the practivated fibers.

4. The method as claimed in claim 1, characterized in that the diisocyanates used during the preactivation step are block diisocyanates.

5. The method as claimed in claim 1, characterized in that it comprises, before the extrusion step, a step of unblocking the diisocyanates present on the preactivated fibers.

6. The method as claimed in claims 3 and 5, characterized in that the unblocking step takes place simultaneously with the drying step.

7. The method as claimed in claim 1 or 2, characterized in that the thermoplastic material used for the extrusion step is implemented by maelic anhydride groups.

8. A glass fiber reinforcement capable of being obtained by means of the method as claimed in one of claims 1 to 7.

9. A profiled article based on thermoplastic elastomer incorporated a reinforcement as claimed in claim 8.
